(19) United States
(12) Patent Application Publication
(10) Pub. No.: US 2002/0157418 A1
(43) Pub. Date: Oct. 31, 2002

(54) Process for reducing or eliminating bubble defects in sol-gel silica glass

(76) Inventors: Rahul Ganguli, Camarillo, CA (US); Steven G. Colbern, Ventura, CA (US); Matthew S. Gleason, Woodland Hills, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 10/101,437

(22) Filed: Mar. 18, 2002

Related U.S. Application Data
(60) Provisional application No. 60/277,437, filed on Mar. 19, 2001.

(51) Int. Cl. C03B 8/02

(52) U.S. Cl. 65/17.2

(57) ABSTRACT

This invention resides in a process for making silica articles having few or no visible bubbles by sintering silica gels derived from a sol-gel process. The process incorporates control of pH during hydroxylation and gelation, as well as chlorination at temperatures previously considered unsuitable. The process optionally incorporates addition of dispersant to the silica solution.

This application claims priority from U.S. Provisional Application Serial No. 60/277,437 filed Mar. 19, 2001. This invention relates generally to methods for reducing or eliminating bubbles in the manufacture of silica glass articles and, more particularly, to methods that include sintering porous xerogels/aerogels derived from a sol-gel process.

### BACKGROUND OF THE INVENTION

Pending U.S. patent application Ser. No. 09/516,688 to Ganguli et al., hereby incorporated by reference, discloses a method for synthesizing a gel from a sol having a high loading of silica. This high loading of silica is made possible primarily by use of a concentrated paste of fumed silica (e.g., Aerosil OX-50, marketed by Degussa, AG of Frankfurt, Germany) in water. The fumed silica paste is prepared without using any dispersing agents and is then combined with a silica alkoxide precursor, such as tetraethoxysilane, to produce a sol. The sol then is gelled, dried, and sintered to yield synthetic silica glass. The method of this pending application allows for the formation of high quality synthetic silica glass at a low cost. However, this process can result in a small number of bubbles being formed in the sintered glass produced. These bubbles are unacceptable when the glass is to be used for optical applications.

Two common methods have been used in the past to obtain bubble-free silica glass sintered from sol-gel-derived porous xerogels/aerogels. In the first method, described in, for example, U.S. Pat. No. 4,622,056 to Matsuo et al., the glass is sintered, or densified, in a helium atmosphere under either atmospheric or reduced pressure. Because of their small size, helium atoms easily pass through the pores of the porous xerogels/aerogels, and therefore the helium is not trapped in the glass to form bubbles. In the second method for obtaining bubble-free silica glass, described in, for example, U.S. Pat. No. 5,236,483 to Miyashita et al., the glass is sintered at a temperature above the silica's melting temperature of 1,734° C. for a duration sufficient to eliminate bubbles and other defects in the glass. Typically, the temperature used to obtain completely bubble-free glass ranges between about 1,800° C. and about 1,850° C. Though generally successful, neither of the two methods described above yields bubble-free glass when used to treat subcritically dried gels having high silica loading. At best, these methods yield glass having a bubble count on the order of 10 to 25 bubbles/cc.

It should be appreciated from the foregoing description that there is a need for an improved process for sintering sol-gel-derived silica gels, particularly gels that incorporate high silica loading, which can be used effectively to produce glass articles that have low bubble counts, or are substantially free of bubbles. The present invention fulfills this need and provides further related advantages.

### SUMMARY OF THE INVENTION

The present invention resides in a process for making synthetic silica glass. The process includes: mixing fumed silica, water and acid to form a paste having a pH less than about 2.2, and most preferably about 2.0; mixing into the paste an alkoxysilane to form a liquid; and adding a base to the liquid to increase the pH of the liquid to between about 2.8 and 3.6, preferably between about 3.0 and 3.2, and most preferably to about 3.0, to form a sol. The sol then is gelled and dried using a subcritical drying method to form a dry gel, and the dry gel is heated in an atmosphere comprising chlorine gas to a temperature ranging between about 950° C. and about 1,200° C., more preferably between about 1,000° C. and about 1,100° C., and most preferably about 1,050° C., for a duration sufficient to chlorinate and dehydroxylate the dry gel. Then, the dry gel is heated in an atmosphere free of chlorine gas for a duration sufficient to dechlorinate the dry gel. Finally, the dry gel is heated to a temperature and for a duration sufficient to form the synthetic silica glass.

In the process, the fumed silica preferably is fumed silica powder having an average particle size of less than about 100 nm in diameter. The process may also include a step of heating the glass for a duration and at a temperature below about 1,734° C. sufficient to remove inclusions in the glass.

In a preferred aspect, the process further includes a step of mixing a dispersant into the paste before the step of mixing in an alkoxysilane. The dispersant preferably includes a quaternary ammonium salt, such as cetyl trimethyl ammonium bromide, cetyl trimethyl ammonium chloride, dodecyl dimethyl ammonium bromide, or mixtures of these. Preferably, the paste includes between about 0.25 to 1.0 percent by weight of the quaternary ammonium salt.

The present invention also resides in a process for making synthetic silica glass incorporating the steps of: mixing fumed silica powder, water and acid, to form a paste having a pH of about 2.0; mixing into the paste a quaternary ammonium salt; mixing into the paste tetra-alkoxysilane to form a liquid; adding base to the liquid to increase the pH of the liquid to about 3.0 to form a sol; gelling the sol and drying the gel formed using a subcritical drying method; placing the dry gel in an atmosphere including chlorine gas at a temperature of about 1,050° C. for a duration sufficient to chlorinate and dehydroxylate the dry gel; placing the dry gel in an atmosphere essentially free of chlorine gas at a temperature and for a duration sufficient to dechlorinate the dry gel; and heating the dry gel at a temperature and for a duration sufficient to form the synthetic silica glass.

### BRIEF DESCRIPTION OF THE DRAWING

FIG. 1 is a graphical representation of the relationship between cumulative pore volume and pore radius of an unheated gel, a gel chlorinated at 950° C., and a gel chlorinated at 1,050° C.

### DETAILED DESCRIPTION OF THE PREFERRED PROCESS

The present invention resides in a process for the synthesis of gels and sintering of the dried gels into dense, transparent silica glass, with reduction or elimination of bubble defects in the glass. The process provides for reduction of inter-aggregate voids in the gels through careful control of the hydrolization pH and gelation pH, as well high-temperature chlorination of the gel, to eliminate bubble defects in the glass. To eliminate visible bubbles completely, the process incorporates use of a dispersant to prevent aggregation of silica in the gels. These steps of the process are discussed in detail below.

### High-Temperature Chlorination

It is known in the art to remove hydroxyl ions from sol-gel-derived glass using chlorine gas. In addition to the formation of pores discussed above, this use of chlorine gas also can lead to bubble defects. Satoh, et al., Journal of Non Crystalline Solids, 2 17 (1997), pp. 22-29, indicates that exposure to chlorine gas at 800° C. is sufficient for dehydroxylation. Therefore, it has been taught in the art to avoid chlorination at higher temperatures—i.e., above 900° C. for pure alkoxide gels and above 1,000° C. for hybrid alkoxide colloidal gels—because of increased chlorine entrapment within the pores of the gel matrix at higher temperatures. This trapped chlorine gas can create bubbles if the glass then is sintered at higher temperatures.

In contrast to the prior art, in which lower temperature chlorination has been used to remove hydroxy ions or impurities, the process of the present invention incorporates chlorination at a temperature between 950° C. and 1,200° C., more preferably between 1,000° C. and 1,100° C., and most preferably at about 1,050° C., to obtain bubble-free glass. Experiments have shown that performing the chlorination step at the specified higher temperatures broadens the intra-aggregate pores of the gel matrix, enabling chlorine molecules to escape more easily during the subsequent dechlorination step.

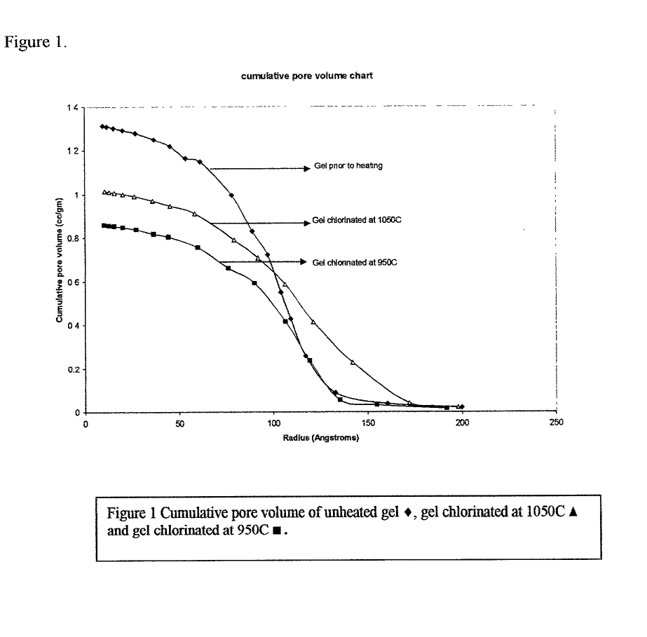

These results are illustrated in FIG. 1, which shows the relationship between cumulative pore volume and pore radius for three different gel conditions: (1) a gel prior to heating, (2) a gel chlorinated at 950° C. for two hours, and (3) a gel chlorinated at 1,050° C. for two hours. The latter two gels subsequently were dechlorinated at 1,075° C. for 24 hours. The gel chlorinated at 1,050° C. exhibited increased cumulative pore volume for pores of radius greater than 10 nm, as compared to the gel prior to heating. However, gels chlorinated at 950° C. did not show such an increase.

Chlorination at higher temperatures leads to the “etching out” of the silica gel (i.e., loss of material from the gel), which leads to the broadening of pore structure, as implied by the results shown in FIG. 1. Gels chlorinated at lower temperatures do not show a similar etching out and resulting pore broadening. This broadening is the principal structural difference between gels chlorinated consistent with the process of the present invention and gels chlorinated at temperatures below 1,000° C., as previously known. While not intending to limit the scope of the present invention by any theory, it is speculated that this etching out of silica opens escape paths for gases trapped in the gel, which otherwise might later have formed bubbles.

### Reducing Aggregate Void Size

As discussed in E. M. Rabinovich, “Particulate Silica Gels and Glasses from the Sol-Gel Process”, in Sol-Gel Technology for Thin Films, Electronics and Specialty Shapes, Ed. Lisa Klein, pp. 260-292, Noyes Publications, 1988, another reason for the formation of bubbles in glass may be the existence of large inter-aggregate voids in the gel structure.

U.S. patent application Ser. No. 09/516,688 to Ganguli et al. (“the '688 application”), discussed above, discloses that use of its method leads to large inter-aggregate voids in the resulting dry gels. However, in the process of the '688 application, this distribution forms as a result of use of a starting material that is a combination of fumed silica powder and a liquid alkoxide silica precursor. Fumed silica aggregates during gelation, and the alkoxide silica simply gels around the aggregated fumed silica. This leads to a bimodal pore size distribution, with intra-aggregate pores due to the gelation of the alkoxide silica, and inter-aggregate voids due to the aggregation of fumed silica. These inter-aggregate voids lead to the formation of bubble defects in the resulting glasses.

The Rabinovich article teaches that the method to obtain bubble-free glass from such a gel is to ensure that the inter-aggregate pore size is small. The process described in the article achieves this by ball milling the disclosed starting aggregates of silica. Mechanical means, such as ball milling, are time-consuming and costly, and they can impart impurities into the silica article. Therefore, in the process of the present invention, an alternative method has been used to reduce aggregate void size. Reduction of the size of these inter-aggregate voids is achieved by a combination of hydrolyzing at a low pH, gelling at a low pH, and using a very small amount of dispersant, in addition to the high temperature chlorination discussed above. The hydrolyzation pH is controlled to be below about 2.2, most preferably at about 2.0. The gelation pH is controlled in a tight range between 2.8 and 3.6, most preferably at about 3.0. The dispersant used is a quaternary ammonium salt, such as cetyl trimethyl ammonium bromide (CTAB), cetyl trimethyl ammonium chloride (CTACl), or dodecyl dimethyl ammonium bromide (DDAB). As discussed above, the higher temperature chlorination leads to the “etching out” of silica at the higher temperatures.

The process of the present invention can be better understood by way of the following illustrative examples.

### EXAMPLE 1

This Example illustrates the preferred process of the present invention for making glass free of visible bubbles. The Example includes steps known in the art, with the additions of use of dispersant, high temperature chlorination, and control of hydrolization pH and gelation pH.

Approximately 30 to 144 grams (most preferably 90 grams) of fumed-silica powder having average particle size less than 100 nm (e.g., Aerosil OX-50) is slowly added to 180 grams of acidified, de-ionized water having a pH of 2.0 to form a viscous paste, for a preferred fumed-silica:H₂O mole ratio of 3:20, as is known in the art. The acid used is chosen from hydrochloric acid (HCl), nitric acid (HNO₃), acetic acid (CH₃COOH), sulfuric acid (H₂SO₄), or combinations of these, as is known in the art. To this paste, 0.25 weight percent of CTAB is added. Alternatively, other quaternary ammonium salt dispersants, such as CTACl, and DDAB can be used. Addition of the dispersant thickens the paste. To this resulting thick paste, 208 grams of tetra-ethoxysilane (TEOS) is added, resulting in a TEOS:H₂O mole ratio of 1:10, as is known in the art. Other alkoxysilanes known to be suitable for making silica glass also may be used. A two-phase mixture results. This mixture is slowly mixed together, and after about 30 minutes, a white single-phase liquid results. A base, such as an ammonia solution having a pH of 10.90, is added to the liquid until the pH of the liquid is 3.0. Once the base has been added, the liquid is referred to as the “sol.” This sol at pH of 3.0 then is gelled and aged according to methods known in the art. Drying is carried out using a subcritical drying process, according to the method described in U.S. Pat. No. 5,473,826 to Kirkbir et al.

A high temperature chlorination protocol is then followed for the final sintering of the glass. The gel that has formed from the sol is heated at a rate of 100° C./hour to a temperature of 200° C. in air and held at that temperature for 2 hours to remove water vapor. Next, the gel is heated to 650° C. at a rate of 100° C./hour and held at that temperature for 3 hours to prepare the gel for chlorination. Next, to begin chlorination, the atmosphere in the furnace is changed to a mixture of 60% helium, 35% chlorine and 5% oxygen. The gel is then held for another hour at 650° C. Next, the gel temperature is increased over 8 hours to a final temperature of 1,025° C. Finally, the gel temperature is increased to 1,050° C. and held at this temperature for 2 hours. After this period, the atmosphere in the furnace is changed to a mixture of 95% helium and 5% oxygen to begin dechlorination. The gel is held at 1,050° C. for 24 hours. After this period, the atmosphere in the furnace is changed to pure helium. The temperature of the gel is increased to 1,375° C. at a rate of 25° C./hour, and the gel is sintered at 1,375° C. for 5 hours. After a final stress relief step is carried out at 1,200° C. for 1 hour, the glass is cooled to room temperature.

Examination of the glass produced demonstrates that there exist some inclusions (i.e., particulates) visible in the glass, but no bubbles. The inclusions in the glass are removed by heating the glass to a temperature below the melting point of silica of 1,734° C., and holding at that temperature for 10 minutes. On completion of this high-temperature step, a glass free of visible defects, from either bubbles or inclusions, is obtained.

### EXAMPLE 2

This Example illustrates the preferred process described in Example 1, modified by using a greater amount of dispersant. A sol is prepared as described in Example 1 above, except using 1 weight percent rather than 0.25 weight percent CTAB. The sol is gelled, aged, dried, and sintered as described in Example 1. The glass obtained has no visible defects. However, it should be noted that higher dispersant concentration increases the expense of the process and introduces higher levels of impurities into the glass.

### EXAMPLE 3

This Example illustrates the preferred process in which dispersant is not added to the solution. Approximately 120 grams of OX-50 silica powder is slowly added to 180 grams of acidified deionized water having a pH of 2.6 to form a viscous paste, for a preferred fumed-silica:H₂O mole ratio of 1:5. The acid is chosen from those described above in Example 1. To this paste, 208 grams of TEOS is added, resulting in a TEOS:H₂O mole ratio of 1:10. Other alkoxysilanes known for use in making silica glass also can be used. The resulting two-phase mixture then is slowly mixed together. After about 180 minutes, a clear, white single-phase mixture results. This single-phase liquid is ultra-sonica ted for 5 minutes. Then, a base, such as approximately 3 ml of ammonia water having a pH of 10.90, is added dropwise to the liquid to bring the pH of the liquid to 3.0 and form a sol. This sol then is gelled, dried, and aged according to the methods described in U.S. Pat. No. 5,473,826 to Kirkbir et al.

Next, the high-temperature chlorination proceeds as described for Example 1 above, except the sintering process is completed at a temperature of 1,300° C. for 4 hours, instead of 1,375° C. for 5 hours. After the final stress relief step, as described for Example 1 above, the gel is cooled to room temperature, and inclusions are removed as described in Example 1. On completion of this high temperature step, glass having a bubble count of just 1-2 bubbles/cc is obtained.

The results of this Example indicate that, even without the use of dispersant in the gel solution, substantial reduction in bubble defects can be obtained using the process of the present invention. However, production of bubble-free glass appears to require use of dispersant, as illustrated in Examples 1 and 2.

### EXAMPLE 4

A sol is prepared as described in Example 1 above, except that base is added to bring the pH to 3.6, rather than 3.0. The sol is gelled, aged, dried, and sintered as described in Example 1. The glass obtained exhibits bubbles. This Example indicates that gelation pH less than 3.6 is necessary for manufacture of bubble-free glasses using the process of the present invention, and that use of dispersant alone is not sufficient.

### EXAMPLE 5

A sol is prepared as described in Example 1 above, except that base is added to bring the pH to 2.8, rather than 3.0. The sol is gelled, aged, dried, and sintered as described in Example 1. In this example, the gel is cracked and in pieces. This Example indicates that gelation pH greater than 2.8 is necessary to prevent cracking of the gels produced.

### EXAMPLE 6

A dried gel is formed according to the process described in Example 1. Then, the gel is heated as described in Example 1, except that the step of chlorination takes place at 950° C., instead of 1,050° C. That is, after addition of chlorine to the atmosphere, the temperature is ramped up to and held at 950° C. The dechlorination, sintering, and inclusion removal steps are completed as in Example 1. The glasses formed have a bubble count of about 10-25 bubbles/cc. This example illustrates that when the chlorination step is not carried out at a sufficiently high temperature, i.e., greater than 950° C. and preferably at 1,050° C., substantial bubble defects can result, even when pH is controlled and dispersant is added.

The above examples indicate that the preferred processes of the present invention incorporating use of dispersant, control of hydrolyzation pH and gelation pH, and high temperature chlorination can produce glass lacking visible bubbles, while the preferred processes of the present invention incorporating all but use of dispersant produce glass having fewer bubbles. No single feature, by itself, is sufficient to produce glasses with fewer or no bubbles than processes known in the art.

Although the invention has been disclosed in detail with reference only to the preferred processes, those skilled in the art will appreciate that additional processes for making glasses can be performed without departing from the scope of the invention. Accordingly, the invention is identified by the following claims.

We claim:

1. A process for making synthetic silica glass, comprising:
mixing together fumed silica, water and acid to form a paste having a pH of less than about 2.2;
mixing into the paste an alkoxysilane to form a liquid;
adding a base to the liquid to increase the pH of the liquid to between about 2.8 and about 3.6 to form a sol;
gelling the sol to form a gel;
drying the gel using a subcritical drying process to form a dry gel;
heating the dry gel in an atmosphere comprising chlorine gas to a temperature ranging between about 950° C. and about 1,200° C. for a duration sufficient to chlorinate and dehydroxylate the dry gel;
heating the dry gel in an atmosphere free of chlorine gas for a duration sufficient to dechlorinate the dry gel; and
heating the dry gel at a temperature and for a duration sufficient to form the synthetic silica glass.

2. A process as defined in claim 1, wherein the step of mixing fumed silica, water and acid comprises mixing fumed silica, water and acid to form a paste having a pH of about 2.0.

3. A process as defined in claim 1, wherein the step of adding a base comprises adding the base to the liquid to increase the pH of the liquid to between about 3.0 and about 3.2.

4. A process as defined in claim 3, wherein the step of adding a base comprises adding the base to the liquid to increase the pH of the liquid to about 3.0.

5. A process as defined in claim 1, wherein the step of heating the dry gel in an atmosphere comprising chlorine gas comprises heating the dry gel to a temperature ranging between about 1,000° C. and about 1,100° C.

6. A process as defined in claim 5, wherein the step of heating the dry gel in an atmosphere comprising chlorine gas comprises heating the dry gel to a temperature of about 1,050° C.

7. A process as defined in claim 1, wherein the fumed silica consists essentially of fumed silica powder having an average particle size of less than about 100 nm in diameter.

8. A process as defined in claim 1, further comprising a step of heating the synthetic silica glass for a duration and at a temperature sufficient to remove inclusions in the glass, the temperature being below about 1,734° C.

9. A process as defined in claim 1, further comprising a step of mixing into the paste a dispersant before the step of mixing into the paste an alkoxysilane.

10. A process as defined in claim 9, wherein the dispersant comprises a quaternary ammonium salt.

11. A process as defined in claim 10, wherein the quaternary ammonium salt consists essentially of cetyl trimethyl ammonium bromide, cetyl trimethyl ammonium chloride, dodecyl dimethyl ammonium bromide, or mixtures thereof.

12. A process as defined in claim 10, wherein the paste comprises between about 0.25 and about 1.0 percent by weight of the quaternary ammonium salt.

13. A process for making synthetic silica glass, comprising:
mixing fumed silica, water and acid to form a paste having a pH of less than about 2.2;
mixing into the paste a dispersant;
mixing into the paste an alkoxysilane to form a liquid;
adding a base to the liquid to increase the pH of the liquid to between about 2.8 and about 3.6 to form a sol;
gelling the sol to form a gel;
drying the gel using a subcritical drying process to form a dry gel;
heating the dry gel in an atmosphere comprising chlorine gas to a temperature ranging between about 950° C. and about 1,200° C. for a duration sufficient to chlorinate and dehydroxylate the dry gel;
heating the dry gel in an atmosphere free of chlorine gas for a duration sufficient to dechlorinate the dry gel; and,
heating the dry gel at a temperature and for a duration sufficient to form the synthetic silica glass.

14. A process as defined in claim 13, wherein the step of mixing fumed silica, water and acid comprises mixing fumed silica, water and acid to form a paste having a pH of about 2.0.

15. A process as defined in claim 13, wherein the step of adding a base comprises adding the base to the liquid to increase the pH of the liquid to between about 3.0 and about 3.2.

16. A process as defined in claim 15, wherein the step of adding a base comprises adding the base to the liquid to increase the pH of the liquid to about 3.0.

17. A process as defined in claim 13, wherein the step of heating the dry gel in an atmosphere comprising chlorine gas comprises heating the dry gel to a temperature ranging between about 1,000° C. and about 1,100° C.

18. A process as defined in claim 17, wherein the step of heating the dry gel in an atmosphere comprising chlorine gas comprises heating the dry gel to a temperature of about 1,050° C.

19. A process as defined in claim 13, wherein the fumed silica consists essentially of fumed silica powder having an average particle size of less than about 100 nm in diameter.

20. A process as defined in claim 13, further comprising a step of heating the glass for a duration and at a temperature sufficient to remove inclusions in the glass, the temperature being below about 1,734° C.

21. A process as defined in claim 13, wherein the dispersant comprises a quaternary ammonium salt.

22. A process as defined in claim 21, wherein the quaternary ammonium salt consists essentially of cetyl trimethyl ammonium bromide, cetyl trimethyl ammonium chloride, dodecyl dimethyl ammonium bromide, or mixtures thereof.

23. A process as defined in claim 22, wherein the paste comprises between about 0.25 and about 1.0 percent by weight of the quaternary ammonium salt.

24. A process for making synthetic silica glass, comprising:
mixing fumed silica powder, water and acid, to form a paste having a pH of about 2.0;
mixing into the paste a quaternary ammonium salt to a weight percentage of about 0.25 weight percent of the paste;
mixing into the paste tetra-alkoxysilane to form a liquid;
adding base to the liquid to increase the pH of the liquid to about 3.0 to form a sol;
gelling the sol to form a gel;
drying the sol using a subcritical drying method to form a dry gel;
placing the dry gel in an atmosphere comprising chlorine gas at a temperature of about 1,050° C. for a duration sufficient to chlorinate and dehydroxylate the dry gel;
placing the dry gel in an atmosphere essentially free of chlorine gas at a temperature and for a duration sufficient to dechlorinate the dry gel;
heating the dry gel at a temperature and for a duration sufficient to form the synthetic silica glass; and
heating the silica glass at a temperature less than about 1,734° C. and for a duration sufficient to remove inclusions from the glass.
